(19) United States
(12) Patent Application Publication
(10) Pub. No.: US 2023/0213944 A1
(43) Pub. Date: Jul. 6, 2023

(54) ROBOT AND CONTROL METHOD THEREFOR

(71) Applicant: SAMSUNG ELECTRONICS CO., LTD., Suwon-si (KR)

(72) Inventors: Aron BAIK, Suwon-si (KR); Myounggon KIM, Seoul (KR); Jewoong RYU, Suwon-si (KR); Eunsoll CHANG, Suwon-si (KR)

(73) Assignee: SAMSUNG ELECTRONICS CO., LTD., Suwon-si (KR)

(21) Appl. No.: 18/120,192

(22) Filed: Mar. 10, 2023

Related U.S. Application Data
(63) Continuation of application No. PCT/KR2021/011019, filed on Aug. 19, 2021.

(30) Foreign Application Priority Data
Sep. 21, 2020 (KR) 10-2020-0121772

(51) Int. Cl. G05D 1/02; G06T 7/50; G06T 7/73

(52) U.S. Cl. CPC G05D 1/0238; G06T 7/50; G06T 7/73; G06T 2207/10028

(57) ABSTRACT

Provided in the present disclosure are a robot and a control method therefor. The robot includes: a depth camera; a driver; and a processor for acquiring a depth image by performing photographing through the depth camera, generating a plurality of 3D points on a three-dimensional (3D) space corresponding to a plurality of pixels, based on depth information about the plurality of pixels of the depth image, identifying a plurality of 3D points having a preset height value, based on a driving bottom surface of the robot in the 3D space from among the plurality of 3D points, and controlling the driver to move the robot based on the identified plurality of 3D points.

### CROSS-REFERENCE TO RELATED APPLICATIONS

This application is a bypass continuation of International Application No. PCT/KR2021/011019, filed on Aug. 19, 2021, in the Korean Intellectual Property Receiving Office, which is based on and claims priority to Korean Patent Application No. 10-2020-0121772, filed on Sep. 21, 2020, in the Korean Intellectual Property Office, the disclosures of which are incorporated herein by reference in their entireties.

### BACKGROUND

### 1. Field

The disclosure relates to a robot and, more particularly, to a robot that travels using a depth image, and a control method thereof.

### 2. Description of Related Art

Recently, robots that can travel on its own and application technology associated therewith are being developed. The robots use simultaneous localization and mapping (SLAM) technology which estimates a position of a robot (localization) in real-time to autonomously move while simultaneously mapping a map.

To this end, robots may perform a position estimation through data obtained by using various sensors. At this time, a vision sensor which obtains an image that projected a space present within a field of view of a camera as a plane and a distance sensor such as a light detection and ranging (LIDAR) sensor which obtains data that scanned a distance from an object in a 360 degree direction may be used in general for the position estimation.

Although a vision sensor such as a camera may be inexpensive and allow for possible miniaturization, A large amount of computational load is required for data processing, and there is a disadvantage of a blur occurring in an image obtained when a robot travels at high-speed or rotates.

In the case of a distance sensor such as a LIDAR, there is a disadvantage of a lifespan being short, cost being high, and miniaturization of the sensor being difficult due to sensing distances in 360 degree direction by rotating the sensor through a rotating device such as a motor. Specifically, in the case of a two-dimensional (2D) LIDAR, there is difficulty in sensing various environments or objects surrounding the robot in that distance may be sensed only at a fixed height (height at which LIDAR is mounted), and in the case of a multi-channel three-dimensional (3D) LIDAR, there is a disadvantage of cost being significantly expensive and size and weight of the sensor being big.

Accordingly, there is a demand for a method for performing the position estimation of a robot by compensating for the disadvantages of the sensors as described above.

### SUMMARY

Provided are a robot that travels using a depth image, and a control method thereof.

Additional aspects will be set forth in part in the description which follows and, in part, will be apparent from the description, or may be learned by practice of the presented embodiments.

According to an aspect of the disclosure, a robot may include a depth camera, a driver, and a processor configured to control the depth camera to obtain a depth image, the depth image including depth information of a plurality of pixels in the depth image, generate a first plurality of three-dimensional (3D) points corresponding to the plurality of pixels in a 3D space based on the depth information, identify, from among the first plurality of 3D points, a second plurality of 3D points having a predetermined height value based on a floor on which the robot travels in the 3D space, and control the driver to move the robot based on the second plurality of 3D points.

The processor may be further configured to determine, based on a distribution of the second plurality of 3D points in the 3D space, the floor on which the robot travels in the 3D space.

The processor may be further configured to rotate the second plurality of 3D points in the 3D space such that the determined floor is mapped on a predetermined plane in the 3D space, and identify, from among the rotated second plurality of 3D points, a third plurality of 3D points with the predetermined height value based on the predetermined plane.

The predetermined plane may correspond to an XZ plane in the 3D space that is defined by a X-axis, a Y-axis, and a Z-axis, and the processor may be further configured to identify, from among the rotated second plurality of 3D points, a fourth plurality of 3D points of which a Y-axis value has a predetermined value.

The processor may be further configured to convert the fourth plurality of 3D points to two-dimensional (2D) data based on a X-axis value and a Z-axis value of the fourth plurality of 3D points and control the driving unit for the robot to travel based on the 2D data.

The processor may be further configured to identify, from the first plurality of 3D points, a fifth plurality of 3D points with a height value that is within a predetermined threshold range, the predetermined threshold range including the predetermined height value, and control the driver to move the robot to travel based on the fifth plurality of 3D points.

The predetermined height value may be a height value set based on a height value of the robot.

According to an aspect of the disclosure, a method of controlling a robot may include obtaining a depth image by a depth camera provided in the robot, the depth image including depth information of a plurality of pixels in the depth image, generating a first plurality of 3D points corresponding to the plurality of pixels in a 3D space based on the depth information, identifying, from among the first plurality of 3D points, a second plurality of 3D points with a predetermined height value based on a floor on which the robot travels in the 3D space, and controlling a driver included in the robot to move the robot based on the second plurality of 3D points.

The identifying may include determining, based on a distribution of the second plurality of 3D points in the 3D space, the floor on which the robot travels in the 3D space.

The identifying may include rotating the second plurality of 3D points in the 3D space such that the determined floor is mapped on a predetermined plane in the 3D space, and identifying, from among the rotated second plurality of 3D points, a third plurality of 3D points with the predetermined height value based on the predetermined plane.

The predetermined plane may correspond to an XZ plane in the 3D space that is defined by a X-axis, a Y-axis, and a Z-axis, and the identifying may include identifying, from among the rotated second plurality of 3D points, a fourth plurality of 3D points of which a Y-axis value has a predetermined value.

The identifying may include converting the second plurality of 3D points to 2D data based on a X-axis value and a Z-axis value of the second plurality of 3D points, and the controlling may include controlling the driver to move the robot based on the 2D data.

The identifying may include identifying, from the first plurality of 3D points, a fifth plurality of 3D points with a height value that is within a predetermined threshold range that includes the predetermined height value based on the floor.

The predetermined height value may be a height value set based on a height value of the robot.

### BRIEF DESCRIPTION OF DRAWINGS

The above and other aspects, features, and advantages of certain embodiments of the present disclosure will be more apparent from the following description taken in conjunction with the accompanying drawings, in which

FIG. 1 is a diagram illustrating a robot according to an embodiment of the disclosure;

FIG. 2 is a block diagram illustrating a configuration of a robot according to an embodiment of the disclosure;

FIG. 3A is a diagram illustrating a method of generating a three dimensional (3D) point through a depth image according to an embodiment of the disclosure;

FIG. 3B is a diagram illustrating a method of generating a 3D point through a depth image according to an embodiment of the disclosure;

FIG. 4A is a diagram illustrating a method of identifying a floor according to an embodiment of the disclosure;

FIG. 4B is a diagram illustrating a method of identifying a floor according to an embodiment of the disclosure;

FIG. 5A is a diagram illustrating a method of arranging a plurality of 3D points according to an embodiment of the disclosure;

FIG. 5B is a diagram illustrating a method of arranging a plurality of 3D points according to an embodiment of the disclosure;

FIG. 5C is a diagram illustrating a method of arranging a plurality of 3D points according to an embodiment of the disclosure;

FIG. 6A is a diagram illustrating a method of identifying a 3D point of a specific height according to an embodiment of the disclosure;

FIG. 6B is a diagram illustrating a method of identifying a 3D point of a specific height according to an embodiment of the disclosure;

FIG. 7 is a diagram illustrating a method of generating 2D data according to an embodiment of the disclosure;

FIG. 8 is a diagram illustrating additional configurations of a robot according to an embodiment of the disclosure; and

FIG. 9 is a diagram illustrating a flowchart of a method of controlling a robot according to an embodiment of the disclosure.

### DETAILED DESCRIPTION

In the disclosure, in case it is determined that the detailed description of related known technologies or configurations may unnecessarily confuse the gist of the disclosure, the detailed description thereof will be omitted. Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

It should be noted that the various embodiments are not for limiting the scope of the disclosure to a specific embodiment, but should be interpreted to include all modifications, equivalents and/or alternatives of the embodiments. In describing the embodiments, like reference numerals may be used to refer to like elements.

Expressions such as “first,” “second,” “1st,” “2nd,” and so on used herein may be used to refer to various elements regardless of order and/or importance. Further, it should be noted that the expressions are merely used to distinguish an element from another element and not to limit the relevant elements.

In the disclosure, expressions such as “A or B,” “at least one of A and/or B,” or “one or more of A and/or B” may include all possible combinations of the items listed together. For example, “A or B,” “at least one of A and B,” or “at least one of A or B” may refer to all cases including (1) at least one A, (2) at least one B, or (3) both of at least one A and at least one B.

A singular expression includes a plural expression, unless otherwise specified. It is to be understood that the terms such as “configured” or “included” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element). On the other hand, when a certain element (e.g., first element) is indicated as “directly coupled with/to” or “directly connected to” another element (e.g., second element), it may be understood as the other element (e.g., third element) not being present between the certain element and the another element.

The expression “configured to... (or set up to)” used in the disclosure may be used interchangeably with, for example, “suitable for...,” “having the capacity to...,” “designed to...,” “adapted to...,” “made to...,” or “capable of...” based on circumstance. The term “configured to... (or set up to)” may not necessarily mean “specifically designed to” in terms of hardware. Rather, in a certain circumstance, the expression “a device configured to...” may mean something that the device “may perform...” together with another device or components. For example, the phrase “a processor configured to (or set up to) perform A, B, or C” may mean a dedicated processor for performing a corresponding operation (e.g., embedded processor), or a generic-purpose processor (e.g., a central processing unit (CPU) or an application processor) capable of performing the corresponding operations by executing one or more software programs stored in the memory device.

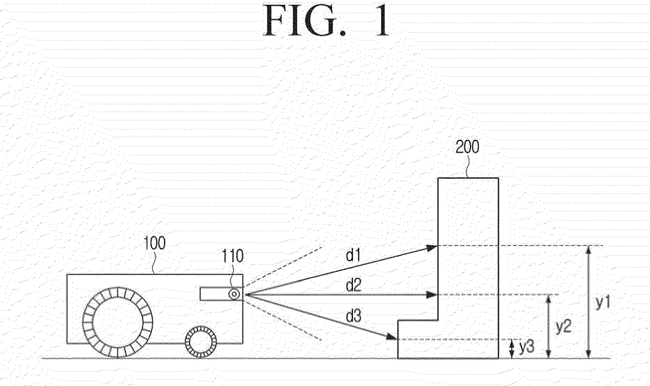

FIG. 1 is a diagram illustrating a robot according to an embodiment of the disclosure.

Referring to FIG. 1, a robot 100 according to an embodiment of the disclosure may be a device which can travel a specific zone. In this case, the robot 100 may provide a specific service to a user while moving in the specific zone. For example, the robot 100 may be realized into a device capable of providing various services such as, for example, and without limitation, a cleaning robot, a maintenance robot, an exploration robot, a transport robot, and the like.

The robot 100 may travel according to various traveling methods based on various sensing data. The sensing data, as data of a surrounding environment of the robot 100, may be utilized as map data, and the sensing data may include a depth image. In addition, the sensing data may be used in estimating a position of the robot 100 or in generating a map. A traveling method may include at least one from among a walking type which uses legs such as a human or an animal, a wheel type (or a caterpillar type) which uses a rotation of a wheel, a flying type which uses a rotation of a wing or spraying of fuel, and the like.

The robot 100 according to an embodiment of the disclosure may generate a map of a specific height based on the depth image, and travel based on the map.

Specifically, the robot 100 may obtain a depth image by performing a capturing of the surrounding environment through a depth camera 110. The depth image may include depth information mapped at each of a plurality of pixels. The depth information may represent a distance between a position of the depth camera 110 and a position of an object 200. For example, as in FIG. 1, assuming that the robot 100 and the object 200 are placed on a same axis, the depth image may include depth information which represents distances (e.g., d1, d2, and d3) between the position of the robot 100 (e.g., position of height y2) and positions of the objects 200 (e.g., positions of heights y1, y2, and y3). At this time, the object 200 may refer to a thing or an animal present in the surrounding environment of the robot 100, and may refer to, for example, a wall, a door, a table, a chair, a carpet, a cat, a person, or the like.

The robot 100 may generate a plurality of three-dimensional (3D) points based on the depth image. The 3D points may be defined as virtual 3D spatial coordinates (e.g., coordinates of x, y, and z), and the coordinates of the 3D points may correspond to a position in real space. In addition, the 3D points generated (or converted) based on the depth image may represent information of what object being present at a corresponding position. That is, using the distance from the object 200 mapped by the plurality of pixels in the depth image and each pixel coordinates, the object 200 may be generated in the plurality of 3D points that has specific positions respectively in a 3D space. As described above, the robot 100 may convert the depth image to the plurality of 3D points. In this case, the plurality of 3D points may be designated as a point cloud.

The robot 100 may identify a plurality of 3D points of a predetermined height based on a floor from among the plurality of 3D points, and travel based on the identified plurality of 3D points.

The floor may be used as a reference surface to generate map data of a predetermined height. The predetermined height may be a height of the robot 100, but this is merely one embodiment, and may be set to a height which takes into consideration the environment in which the robot 100 travels. For example, based on the robot 100 being a cleaning robot or the like that travels in an environment such as a household, the predetermined height may be set to a height of a threshold (e.g., a door sill) from among the structures within the household.

The identified plurality of 3D points may be used to generate a map of the predetermined height or used to estimate a position of the robot 100 on a map. For example, the robot 100 may identify, based on depth images being consecutively obtained according to time through the depth camera 110 while traveling, a plurality of 3D points of a predetermined height that corresponds to the depth images by performing the above-described operation repeatedly. By matching the plurality of 3D points that is identified consecutively according to time in one 3D space, a map of a predetermined height may be generated. In addition, the robot 100 may identify a plurality of 3D points of a predetermined height that corresponds to the most recently obtained depth image, and estimate a position and an orientation of the robot 100 by determining the position and the orientation of a part that matches with the plurality of 3D points identified from a pre-generated map.

According to the various embodiments of the disclosure as described above, a robot 100 that travels using a depth image and a control method therefor may be provided. In addition, according to an embodiment of the disclosure, there is the advantage of obtaining map data of various heights without specific limitation being possible compared to a LIDAR, there may be cost competitiveness, and miniaturization of a sensor may be possible.

The disclosure will be described in greater detail below with reference to the accompanied drawings.

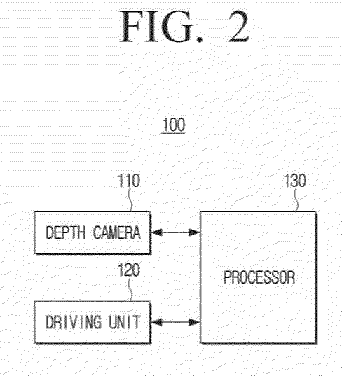

FIG. 2 is a block diagram illustrating a configuration of the robot according to an embodiment of the disclosure.

Referring to FIG. 2, the robot 100 according to an embodiment of the disclosure may include a depth camera 110, a driving unit (or driver) 120, and a processor 130.

The depth camera 110 may obtain a depth image by performing capturing of an area within a field of view (FoV) of the depth camera 110.

The depth image may include a plurality of pixels by which a 3D space in reality is projected as a two dimensional (2D) plane (that is, image plane). The plurality of pixels may be arranged on the 2D plane in a matrix form, and the position of each pixel or the coordinate of each pixel may represent a direction on the 3D space based on the position of the depth camera 110. In addition, at each of the plurality of pixels, depth information may be mapped, and the depth information may represent a distance from the object 200 present in the direction corresponding to the position of the pixel based on the position of the depth camera 110.

To this end, the depth camera 110 may include a lens which focuses visible rays or signals that are received by being reflected by the object 200 to an image sensor and the image sensor that may sense the visible rays or signals. The image sensor may include a 2D pixel array that is divided into a plurality of pixels.

The depth camera 110 may be implemented in a stereo method, a Time-of-Flight (ToF) method, a structured light method, and the like.

The stereo method may represent a method of calculating a distance (or depth) with the object 200 using a disparity of a plurality of images (i.e., difference in position of the same object 200 included in the plurality of images) obtained by simultaneously capturing the object 200 at different positions from each other by two cameras (or at least three cameras) like eyes of a person. The ToF method may represent a method of calculating a distance (or depth) with the object 200 using a difference in time at which a signal (e.g., infrared rays, ultrasonic waves, lasers, etc.) is emitted and a time at which the emitted signal is reflected by the object 200 and sensed, and a rate of the signal. Specifically, the ToF method has an advantage of a distance for identifying the distance of the object 200 being long, power consumption being low, and miniaturization of a product being possible because a volume is small. The structured light method may represent a method of calculating a distance from the object 200 by irradiating structured light which is differentiated from ambient lighting to the object 200 together with a laser such as visible rays, infrared rays, and the like, and sensing a distortion of the structured light that is reflected by the object 200.

In addition, the depth camera 110 may be implemented as a RGB-D camera which can obtain a depth image mapped with depth information and color information (i.e., color values of red, green, and blue) of each of the plurality of pixels.

The depth camera 110 may obtain a plurality of depth images in sequential order through consecutive capturing. At this time, the depth image or meta data separate from the depth image may include information on at least one from among a time, a frame rate, a time point, a FoV, a pixel resolution, and pixel pitch captured by the depth camera 110. The frame rate may represent a number of frames (number of images) obtained per 1 second (or per 1 minute), and the FoV may represent a value which is determined according a focal length of a lens of the depth camera 110 and a size (e.g., diagonal length) of an image sensor of the depth camera 110. In addition, the time point may be sensed by a sensor (e.g., gyro sensor, acceleration sensor, etc.) provided at an inside or outside of the depth camera 110. However, this is merely one embodiment, and the time point may be identified by identifying a part that matches with a plurality of 3D points generated based on a depth image on a map generated by matching the plurality of 3D points and using a degree of misalignment of the parts. The pixel resolution may be, for example, 640 * 480 representing a number of pixels arranged in a horizontal direction (e.g., 640 pixels) and a number of pixels arranged in a vertical direction (e.g., 480 pixels), and the pixel pitch may represent a distance between the adjacent pixels that are spaced apart (e.g., 50 um, etc.).

The depth camera 110 according to an embodiment of the disclosure may obtain a depth image by performing capturing according to a global shutter method. The global shutter may be a method of performing capturing by closing all at once all of the image sensors after simultaneous exposure, and distortion according to disparity may not occur because the capturing time point of one frame is the same. That is, distortion including blurring may be prevented from occurring in the obtained depth image.

Unlike the above, a rolling shutter may be a method of performing capturing by sequentially varying exposure for each horizontal line or vertical line of the image sensor, and in case of a fast moving object, a depth image obtained through this method may be distorted. However, in the disclosure, it should be noted that the rolling shutter method is not excluded from being applied to the depth camera 110 for various reasons such as economic feasibility, miniaturization, and the like.

The driving unit (or driver) 120 may be a device which can drive or move the robot 100, and the driving unit 120 may adjust a traveling direction and traveling speed according to a control of the processor 130. To this end, the driving unit 120 may include a power generating device (e.g., a gasoline engine, a diesel engine, a liquefied petroleum gas (LPG) engine, an electric motor, etc. according to a fuel used (or energy source)) which generates power for the robot 100 to travel, a steering device (e.g., a manual steering, a hydraulics steering, an electronic control power steering (EPS), etc.) for adjusting the traveling direction, a traveling device (e.g., wheel, propeller, etc.) which travels the robot 100 according to power, and the like. The driving unit 120 may be modified and implemented according to a traveling type of the robot 100 (e.g., a wheel type, a walking type, a flying type, etc.).

The processor 130 may obtain a depth image by performing capturing through the depth camera 110, generate a plurality of 3D points corresponding to the plurality of pixels on a 3D space based on depth information of the plurality of pixels in the depth image, identify a plurality of 3D points having a predetermined height value based on the floor on which the robot 100 travels on the 3D space from among the plurality of 3D points, and control the driving unit 120 for the robot 100 to travel based on the identified plurality of 3D points.

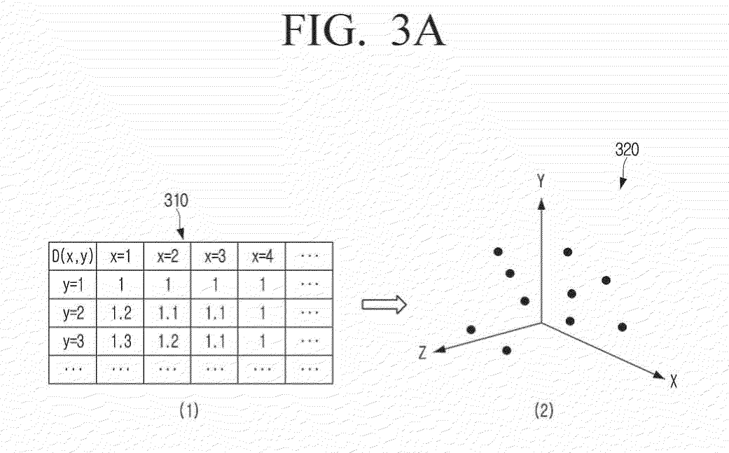

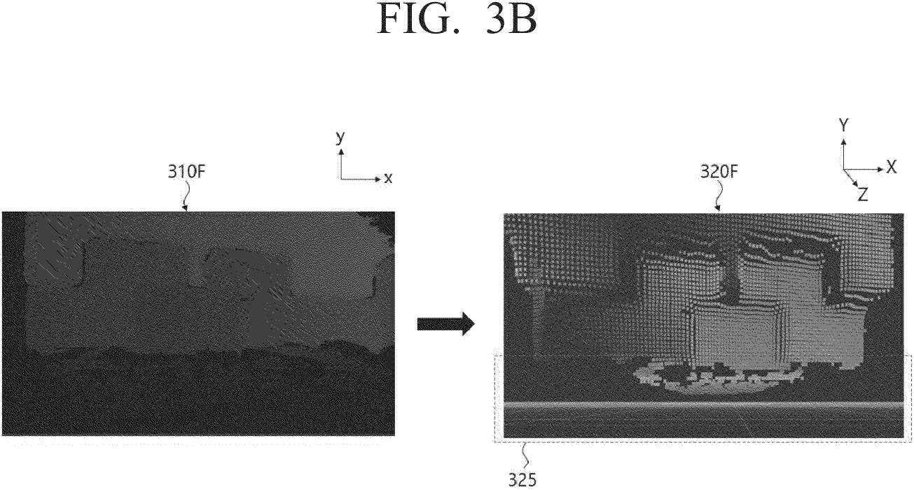

Specifically, the processor 130 may obtain a depth image by performing capturing through the depth camera 110. The processor 130 may generate a plurality of 3D points corresponding to the plurality of pixels in a 3D space based on depth information of the plurality of pixels in the depth image. The above will be described in detail with reference to FIG. 3A and FIG. 3B.

The processor 130 may identify the plurality of 3D points having a predetermined height value based on the floor on which the robot 100 travels in the 3D space from among the plurality of 3D points.

In an embodiment, the processor 130 may determine the floor on which the robot 100 travels in the 3D space based on a distribution of the plurality of 3D points in the 3D space.

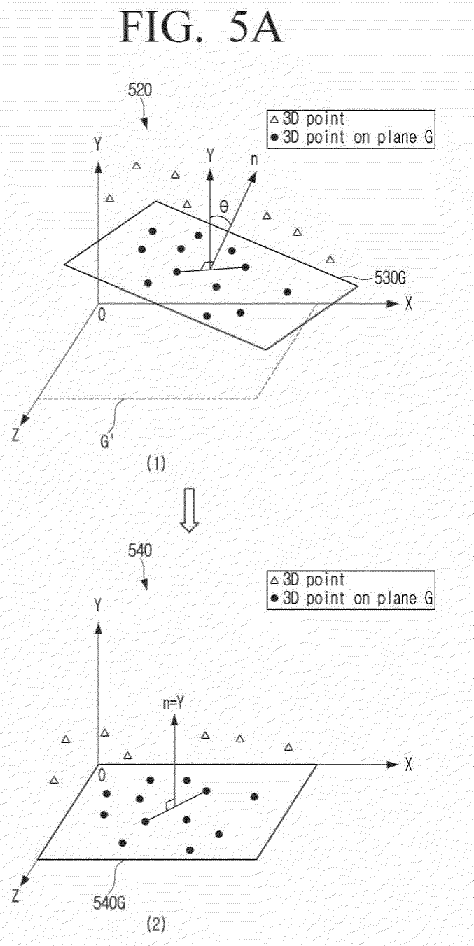

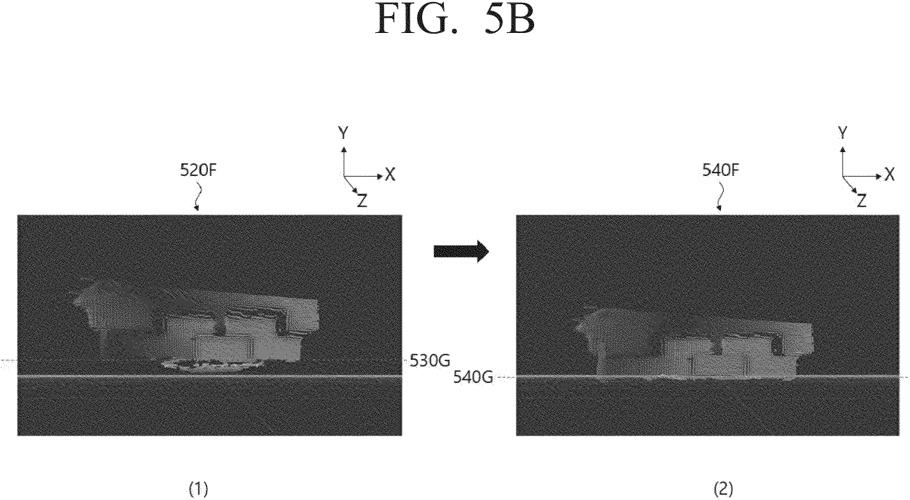

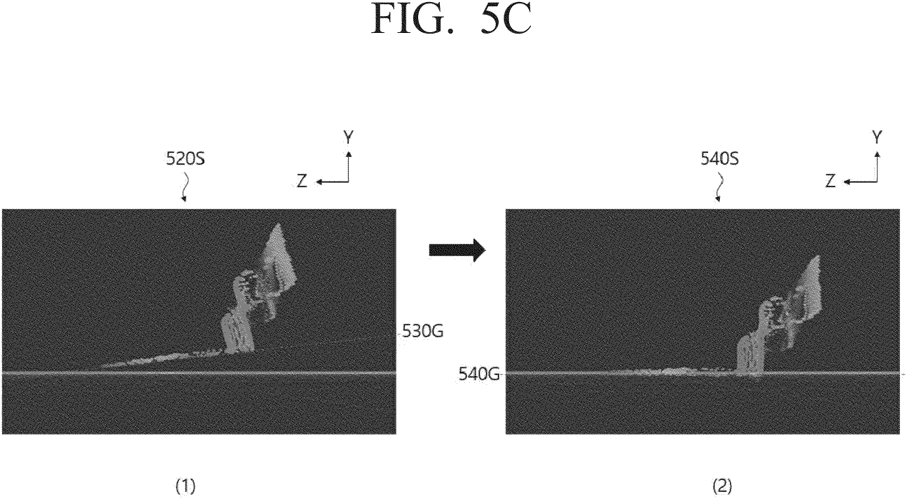

The processor 130 may rotate a plurality of 3D points in the 3D space such that the determined floor is mapped in a predetermined plane in the 3D space. In this case, the predetermined plane may correspond to a XZ plane in the 3D space that is defined by a X-axis, a Y-axis, and a Z-axis. The above will be described in detail with reference to FIG. 5A to FIG. 5C.

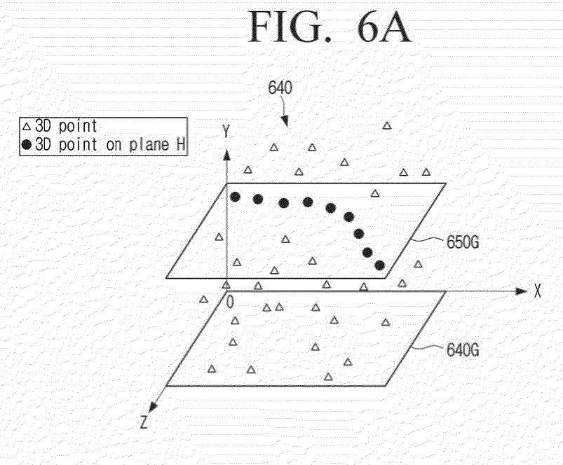

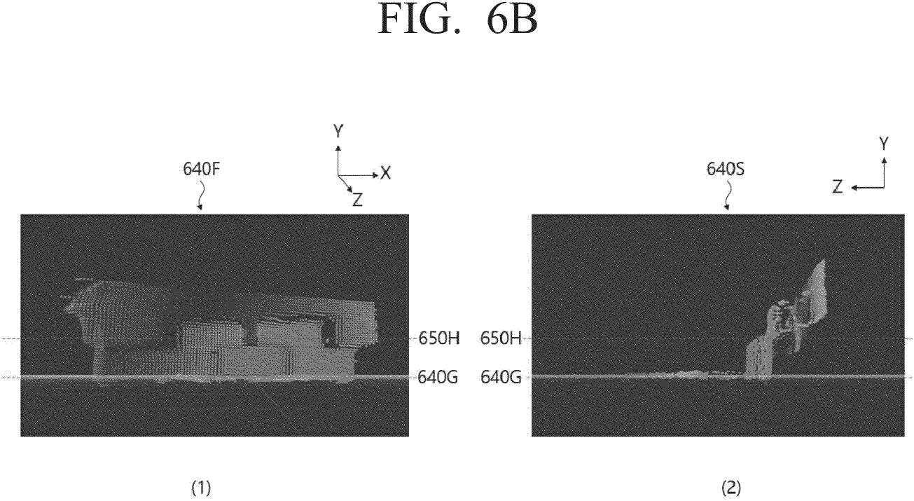

The processor 130 may identify the plurality of 3D points having a predetermined height value based on the predetermined plane from among the rotated plurality of 3D points. In this case, the processor 130 may identify the plurality of 3D points of which a Y-axis value has a predetermined value from among the rotated plurality of 3D points. The above will be described in detail with reference to FIG. 6A and FIG. 6B.

The processor 130 may control the driving unit 120 for the robot 100 to travel based on the identified plurality of 3D points.

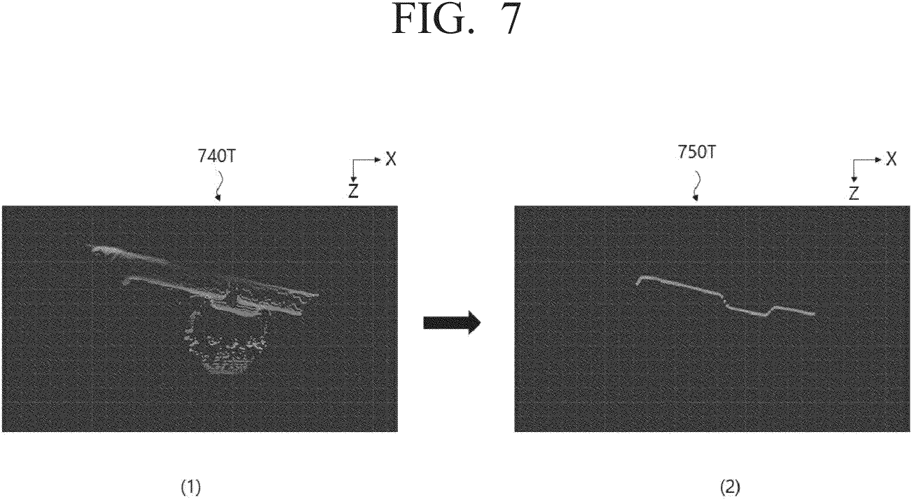

In an embodiment, the processor 130 may convert the identified plurality of 3D points to 2D data based on a X-axis value and a Z-axis value of the identified plurality of 3D points. The processor 130 may control the driving unit 120 for the robot 100 to travel based on the 2D data. The above will be described in detail with reference to FIG. 7.

According to an embodiment of the disclosure, the processor 130 may identify a plurality of 3D points having a height value that is within a predetermined threshold range that includes the predetermined height value based on the floor from among the plurality of 3D points. In this case, the processor 130 may control the driving unit 120 for the robot 100 to travel based on the identified plurality of 3D points.

FIG. 3A and FIG. 3B are diagrams illustrating a method of generating a 3D point through a depth image according to an embodiment of the disclosure.

Referring to (1) of FIG. 3A, the processor 130 according to an embodiment of the disclosure may obtain a depth image 310 by performing capturing through the depth camera 110. The depth image 310 may include depth information mapped on a pixel-by-pixel basis.

In an embodiment, the depth image 310 may be realized as data arranged in a matrix form. A column from the depth image 310 may represent a X-axis coordinate of a pixel, and a row from the depth image 310 may represent a Y-axis coordinate of a pixel. Values mapped in a specific row and column from the depth image 310 may be depth information mapped in the pixel having the corresponding coordinate. For example, among the plurality of pixels (e.g., 640 * 480 pixels) included in the depth image 310, depth information such as 1 meter in a (1, 1) pixel and 1.2 meter in a (1, 2) pixel may be mapped and stored.

Referring to (2) of FIG. 3A, the processor 130 may generate a plurality of 3D points 320 in the 3D space based on depth information of the plurality of pixels and the pixel coordinates included in the depth image 310. Each of the plurality of 3D points 320 may correspond to each pixel in the depth image 310. The 3D points may be positioned in the 3D space having a X-axis, Y-axis, and Z-axis coordinate system, and the position of the 3D points may correspond to a position at which the object 200 is present.

A process of generating a 1st 3D point, which is one from among the plurality of 3D points 320, will be described below as representation of a process of generating the plurality of 3D points 320. For example, the processor 130 may generate the first 3D point having a position (X1, Y1, Z1) according to Equation (1)1 as shown below based on the coordinates mapped in the 1st pixel (e.g., (x1, y1)) and depth information (e.g., d1) included in the depth image 310.

$$\begin{matrix}{X}_{1} = \frac{\left({x}_{1} \text{-} {c}_{x}\right)}{{f}_{x}} {Z}_{1} \\ {Y}_{1} = \frac{\left({y}_{1} \text{-} {c}_{y}\right)}{{f}_{y}} Z 1 \\ {Z}_{1} ≒ {d}_{1}\end{matrix}$$

The 3D space may be set such that a horizontal direction of the depth camera 110 is toward the X-axis, a vertical direction of the depth camera 110 is toward the Y-axis, and an optical axis direction is toward the Z-axis based on a center of a lens of the depth camera 110.

x1 and y1 may represent a row coordinate and a column coordinate of a pixel in the depth image 310, and d1 may represent depth information mapped in the corresponding pixel. In addition, fx and fy may represent a focal length of the depth camera 110 for the X-axis and the Y-axis, cx and cy may represent a position of a principal point for the X-axis and the Y-axis, and the above may be information that is pre-stored in an internal or external memory of the depth camera 110.

Based on the coordinates mapped in the plurality of pixels and depth information included in a depth image 310F in FIG. 3B by the operation as described above, a plurality of 3D points 320F in FIG. 3B may be generated. The plurality of 3D points 320F may be realized in an image form visually representing depth information mapped in each pixel as shown in FIG. 3B. At this time, the depth information may include a contrast ratio (or grayscale) that corresponds to distance from the object 200.

The above-described example is merely one embodiment, and the processor 130 may generate 3D points based on the pixel coordinates and depth information included in the depth image 310 through various geometric relations or various algorithms. In addition, the above-described operation has been described as being performed in the processor 130, but this is merely one embodiment, and the operation of generating the plurality of 3D points based on the depth image 310 may also be performed inside the depth camera 110.

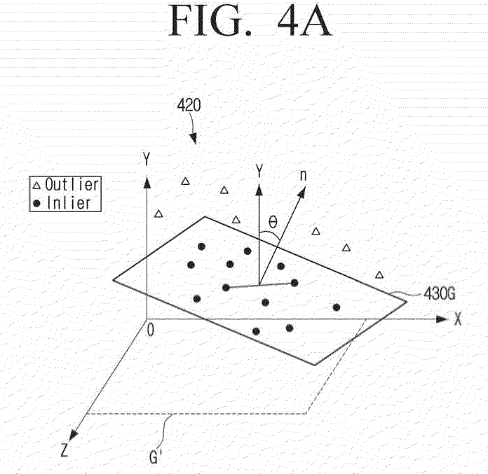

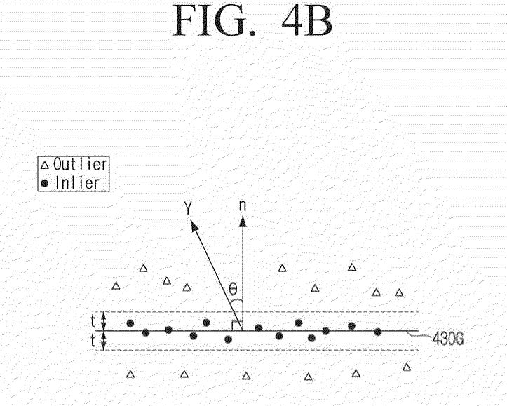

A height of the plurality of 3D points described above may typically be the Y-axis value. However, if there is a likelihood of the floor being inclined, or the height of the floor being measured at a value which is not 0 meters (m), a process of identifying the floor, which is to be a reference for determining height in order to extract the 3D points of a specific height, may be required. A method of identifying the floor will be described in detail below with reference to FIG. 4A and FIG. 4B.

FIG. 4A and FIG. 4B are diagrams illustrating a method of identifying a floor according to an embodiment of the disclosure. FIG. 4A is a diagram viewed from a side surface of a first plane 430G in FIG. 4A.

Referring to FIG. 4A, the processor 130 may determine a floor 430G on which the robot 100 travels in the 3D space based on a distribution of a plurality of 3D points 420 in the 3D space.

For example, the processor 130 may randomly select a plurality of 3D points (e.g., three 3D points) from among the plurality of 3D points 420. The processor 130 may identify the first plane 430G through the positions of the three 3D points and Equation (2) as shown below.

$$\text{O} = A X + B Y + C Z + D$$

<A, B, C> may represent a normal vector n that is perpendicular to the first plane 430G. Values of A, B, C, and D may be obtained through various methods. For example, assuming that the first 3D point is positioned at (X1, Y1, Z1), a second 3D point is positioned at (X2, Y2, Z2), and a third 3D point is positioned at (X3, Y3, Z3), if a simultaneous equation is solved by substituting the first to third 3D points at each of X, Y, and Z in Equation (2), values of A, B, C, and D may be obtained based therefrom.

Referring to FIG. 4B, the processor 130 may consider, from among the plurality of 3D points 420, the 3D point of which a distance from the first plane 430G is within a predetermined distance (e.g., t) as an inlier, and the remaining 3D points excluding the above as an outlier. The processor 130 may calculate the distribution (i.e., number) of 3D points identified as inliers and store in a memory.

The processor 130 may repeat the above-described operation and calculate the distribution of inliers for the second to nth planes (n being a natural number greater than or equal to 2) that is randomly identified. The processor 130 may determine a plane having a biggest distribution from among the distribution of inliers for the first plane 430G to the nth plane as the floor.

The processor 130 according to an embodiment of the disclosure may identify, when randomly selecting 3D points, the 3D point in which a Y value is less than or equal to a predetermined value from among the plurality of 3D points 420, and randomly select a 3D point from among the identified 3D points. The above has an effect of reducing a number of computations for a floor determining process by taking into consideration that the floor is mostly positioned at the bottom in general.

The above-described embodiment is merely one embodiment, and the processor 130 may determine the floor through various algorithms such as, for example, and without limitation, a random sample consensus (RANSAC), an eigenvalue analysis, and the like.

The processor 130 may arrange the plurality of 3D points based on the floor to identify the 3D points having a predetermined height value based on the floor. That is, all of the 3D points may be arranged such that the 3D points corresponding to the floor has a Y-axis value of 0. The above will be described in detail with reference to FIG. 5A to FIG. 5C.

FIG. 5A is a diagram illustrating a method of arranging a plurality of 3D points according to an embodiment of the disclosure. FIG. 5B is a diagram illustrating a method of arranging a plurality of 3D points according to an embodiment of the disclosure. FIG. 5C is a diagram illustrating a method of arranging a plurality of 3D points according to an embodiment of the disclosure.

Referring to (1) of FIG. 5A, the processor 130 may rotate a plurality of 3D points 520 in the 3D space such that a determined floor 530G is mapped on a predetermined plane G′ in the 3D space.

The predetermined plane G′ may correspond to the XZ plane in the 3D space which is defined by the X- axis, the Y- axis, and the Z-axis. The XZ plane may be a plane that has a Y-axis value of 0 such as Y=0.

Specifically, the processor 130 may calculate an angle θ between the normal vector n and a direction vector of the Y-axis by using the normal vector n that is perpendicular to the determined floor 530G and the direction vector of the Y-axis in various methods such as an inner-product of a vector or an outer-product of a vector, or the like. The processor 130 may rotate all of the plurality of 3D points 520 such that the angle θ between the normal vector n and the direction vector of the Y-axis is 0.

In this case, a plurality of points 540 and a floor 540G may be arranged through rotation as shown in (2) of FIG. 5A. At this time, a Y-axis value of the 3D point may represent a height of an object that is based on the floor 540.

Referring to FIG. 5B and FIG. 5C, an example of the plurality of 3D points being arranged according to an embodiment of the disclosure will be described. FIG. 5B shows the plurality of 3D points from a front direction of an object, and FIG. 5C shows the plurality of 3D points from a side direction of an object.

For example, assuming that the floor 530G is determined from among a plurality of 3D points 520F and 520S generated based on the depth image as shown in (1) of FIGS. 5B and (1) of FIG. 5C, the floor 530G may be mapped on a plane having a Y-axis value of 0. In this case, the plurality of 3D points 520F and 520S may be arranged as the floor 540G is mapped on a plane having a Y-axis value of 0 as shown in (2) of FIGS. 5B and (3) of FIG. 5C (2).

The processor 130 may identify a plurality of 3D points having a predetermined height value based on the floor on which the robot 100 travels in the 3D space from among the plurality of 3D points. The above will be described in detail with reference to FIG. 6A and FIG. 6B.

FIG. 6A and FIG. 6B are diagrams illustrating a method of identifying a 3D point of a specific height according to an embodiment of the disclosure.

Referring to FIG. 6A, the processor 130 may identify a plurality of 3D points having a predetermined height value based on the predetermined plane G′ from among a plurality of 3D points 640 that is rotated. At this time, the plurality of 3D points 640 may be rotated such that a floor 640G is mapped on the predetermined plane G′ in the 3D space.

The predetermined plane G′ may correspond to the XZ plane (a plane wherein Y=0) which is the same as the floor 640G. The identified plurality of 3D points may represent a position of an object on a plane having a predetermined height value based on the floor of the robot 100.

That is, the processor 130 may identify, from among the rotated plurality of 3D points 640, a plurality of 3D points of which the Y-axis value has a predetermined value. For example, the plurality of 3D points of which the Y-axis value has a predetermined value h may be 3D points positioned on a H plane 650H where Y=h.

An embodiment of identifying 3D points positioned on the H plane 650H having a predetermined height value based on the above-described floor 640G may be represented as shown in (1) and (2) of FIG. 6B. (1) of FIG. 6B shows the plurality of 3D points from a front direction of an object, and (2) of FIG. 6B shows the plurality of 3D points from a side direction of an object.

In an embodiment, a predetermined height value may be a value based on a height of the robot 100. For example, the predetermined height value may be a value within a range of greater than or equal to 0 and less than or equal to a height value of the robot 100. The above is to estimate a position of the robot 100 or to determine a position of an object that may collide with the robot 100.

In another embodiment, the predetermined height value may be a height value based on a height of a person. For example, the predetermined height value may be a Y-value that corresponds to a height value that is bigger than a height of an average person (e.g., 2 meters). This is to perform a position estimation of the robot 100 more accurately by identifying an interior structure with dynamic objects excluded.

Further, although the predetermined height value has been described as being set with one value, this is merely one embodiment, and the predetermined height value may be set with a plurality of values. In this case, the 3D points for each of the height values may be used in the position estimation of the robot 100.

The embodiments for the above-described predetermined height value are merely one example, and various modifications may be made to the embodiments.

According to an embodiment of the disclosure, the processor 130 may identify a plurality of 3D points having a height value within a predetermined threshold range that includes the predetermined height value based on the floor from among the plurality of 3D points. For example, the height value within a predetermined threshold range may represent, based on the predetermined height value h, a height value between h-a with the predetermined threshold value a subtracted and h+a with the predetermined threshold value a added. That is, the height value within the predetermined threshold range may be a value between the range of greater than or equal to h-a and less than or equal to h+a.

The processor 130 may control the driving unit 120 for the robot 100 to travel based on the identified plurality of 3D points. The above will be described together with reference to FIG. 7.

FIG. 7 is a diagram illustrating a method of generating 2D data according to an embodiment of the disclosure. (1) of FIG. 7 shows a top view of a plurality of 3D points 740T that are arranged projected on the XZ plane, and (2) of FIG. 7 shows a top view of a plurality of 3D points 750T having a predetermined height projected on the XZ plane.

Referring to (1) and (2) of FIG. 7, the processor 130 may convert the identified plurality of 3D points 750T to 2D data based on the X-axis value and the Z-axis value of the plurality of 3D points 750T having a predetermined height identified from among the arranged plurality of 3D points 740T. For example, the processor 130 may omit (or remove) h which is the Y-axis value from among (X, h, Z) values of the 3D point having a predetermined height h and convert to a two-dimensional (2D) point having (X, Z) which is the X-axis value and the Z-axis value. That is, the 2D data may include a plurality of 2D points. In addition, the 2D data may include information on height. The 2D data described above may be utilized as a 2D LIDAR-based SLAM by being converted to a same format as an output value (or input value, etc.) of a 2D LIDAR sensor.

The processor 130 may control the driving unit 120 for the robot 100 to travel based on the 2D data.

Specifically, the processor 130 may generate a plurality of 3D points based on depth images that are periodically obtained, identify the plurality of 3D points having a predetermined height from among the arranged plurality of 3D points, and convert the identified plurality of 3D points to 2D data. In this case, the processor 130 may match the periodically converted 2D data and generate (or update) as a 2D map.

In addition, the processor 130 may generate a plurality of 3D points based on a currently (or at a most recent time) obtained depth image, identify the plurality of 3D points having a predetermined height from among the arranged plurality of 3D points, and convert the identified plurality of 3D points to 2D data. In this case, the processor 130 may compare the currently (or at a most recent time) converted 2D data with the 2D map, and identify the position of the robot 100 on the 2D map.

The processor 130 according to an embodiment of the disclosure may simultaneously perform an operation of generating the above-described 2D map and an operation of estimating a position.

The processor 130 may determine (or plan) a traveling route from the position of the robot 100 to a destination on the 2D map. At this time, various route searching algorithms such as an algorithm for searching a minimum distance traveling route, an algorithm for searching for a route that minimizes changing of traveling direction, and the like, may be used.

The processor 130 may control the driving unit 120 so as to travel along the traveling route to the destination.

According to the various embodiments of the disclosure as described above, a robot that travels using a depth image and a control method therefor may be provided.

In addition, obtaining map data for various heights without specific limitation compared to a LIDAR may be possible in that a depth image is utilized. In addition, in the case of the depth camera 110 which can obtain a depth image, there is the advantage of being cost competitive compared to the LIDAR, and miniaturization of the sensor being possible.

In addition, computational load may be reduced in that a plurality of 3D points having a specific height is processed and not all of the plurality of 3D points generated based on the depth image.

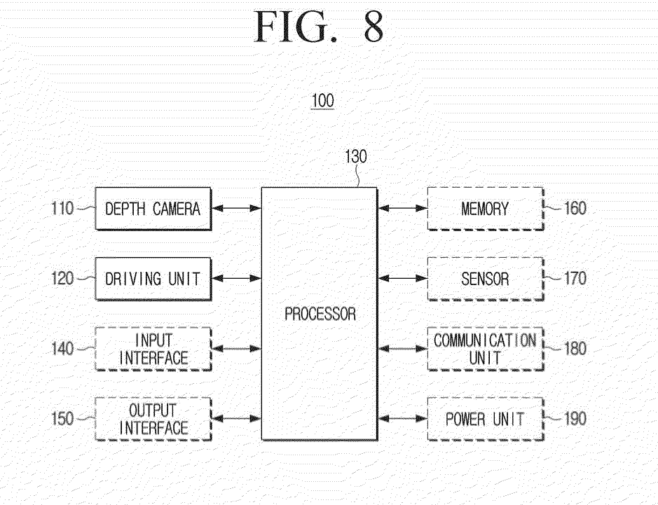

FIG. 8 is a diagram illustrating additional configurations of the robot according to an embodiment of the disclosure.

Referring to FIG. 8, the robot 100 according to an embodiment of the disclosure may further include at least one from among an input interface 140, an output interface 150, a memory 160, a sensor 170, a communication unit 180, and a power unit 190 in addition to the depth camera 110, the driving unit 120, and the processor 130. Descriptions that overlap with the descriptions provided in FIG. 2 will be omitted.

The processor 130 may be implemented as a generic-purpose processor such as a central processing unit (CPU) and an application processor (AP), a graphics dedicated processor such as a graphic processing unit (GPU) and a vision processing unit (VPU), an artificial intelligence dedicated processor such as a neural processing unit (NPU), or the like. In addition, the processor 130 may include a volatile memory for loading at least one instruction or module.

The input interface 140 may receive various user commands and transfer the commands to the processor 130. That is, the processor 130 may recognize a user command input from a user through the input interface 140. The user command may be implemented in various methods such as, for example, and without limitation, a touch input of a user (touch panel), a key (keyboard) or a button (a physical button, a mouse, or the like) input, a user voice (microphone), and the like.

The output interface 150 may be a configuration that can output information, and may be implemented as, for example, a display, a speaker, or the like. It may be a device configured to output display information or data in visual form. The display may display an image frame at one area or whole area of the display which can be driven by pixels. At least a portion of the display may be coupled to at least one from among a front area, a side area, and a rear area of the robot 100 in a form of a flexible display. A characteristic of the flexible display may be being bendable, twistable, or rollable without damage through a substrate that is as thin as paper and flexible. The speaker may output not only various audio data to which various processing operations such as decoding or amplification, and noise filtering are performed by an audio processing unit, but also output various notification sounds or voice messages directly to sound.

The memory 160 may be a configuration for storing an operating system (OS) for controlling the overall operation of elements of the robot 100 and various data associated with the elements of the robot 100.

To this end, the memory 160 may be configured as a hardware that can store data or information temporarily or permanently. For example, the memory 160 may be implemented as at least one hardware from among, for example, a non-volatile memory, a volatile memory, a flash memory, a hard disk drive (HDD) or a solid state drive (SDD), a random access memory (RAM), a read only memory (ROM), and the like.

In the memory 160, at least one instruction, program, or data necessary for the robot 100 or in an operation of the processor 130 may be stored. The instruction may be a code unit that instructs an operation of the robot 100 or the processor 130, and may be prepared in a machine language which is a language that can be understood by a computer. The program may be a series of instruction sets that perform a specific work of a work unit. Data may be status information in bit or byte unit that can represent a character, number, image, and the like.

The sensor 170 may be implemented as various sensors, such as, for example, and without limitation, a camera, a microphone, a proximity sensor, a ambient light sensor, a motion sensor, a ToF sensor, a global positioning system (GPS) sensor, and the like. For example, the camera may divide light into pixel units, sense an intensity of light for red (R), green (G), and blue (B) colors for each pixel, and obtain data in which the intensity of light is converted to an electrical signal and expresses colors, shapes, contrast, and the like of an object. At this time, a type of data may be an image having R, G, and B color values for each of the plurality of pixels. The microphone may sense a sound wave such as a user voice, and obtain data by converting the sound wave to an electrical signal. At this time, the type of data may be an audio signal of various formats. The proximity sensor may sense a presence of a surrounding object, and obtain data on whether a surrounding object is present or whether the surrounding object is in close proximity. The ambient light sensor may sense an amount of light (or brightness) for the surrounding environment of the robot 100, and obtain data on an illuminance. The motion sensor may sense a moving distance, a moving direction, a gradient, and the like of the robot 100. To this end, the motion sensor may be realized through combining an acceleration sensor, a gyro sensor, a geomagnetic sensor, and the like. The TOF sensor may sense a time of light that returns after emitting various electromagnetic waves (e.g., ultrasonic waves, infrared rays, lasers, Ultra-Wideband (UWB), etc.) having a specific speed, and obtain data on a distance (or position) with a subject. The GPS sensor may receive radio-wave signals from a plurality of satellites, calculate respective distances with each satellite using a transfer time of the received signal, and obtain data on a current position of the robot 100 by using the calculated distances for triangulation. However, the embodiment of the above-described sensor 170 is merely one embodiment, and may be implemented to sensors of various types and not be limited thereto.

The communication unit 180 may transmit and receive data of various types by performing communication with external devices of various types according to communication methods of various types. The communication unit 180 may be circuitry that performs wireless communication of various methods, and may include at least one from among a Bluetooth module (Bluetooth method), a Wi-Fi module (Wi-Fi method), a wireless communication module (cellular method such as 3^{rd} generation (3G), 4^{th} generation (4G), 5^{th} generation (5G), etc.), a near field communication (NFC) module (NFC method), an infrared (IR) module (infrared method), a ZigBee module, (ZigBee method),an ultrasound module (ultrasound method), and the like, and an Ethernet module, a universal serial bus (USB) module, a high definition multimedia interface (HDMI), a display port (DP), a D-subminiature (D-SUB), a digital visual interface (DVI), a Thunderbolt, and a component which perform wired communication.

The power unit 190 may supply power for each configuration of the robot 100. For example, the power unit 190 may include a battery that is chargeable by an external commercial use power supply.

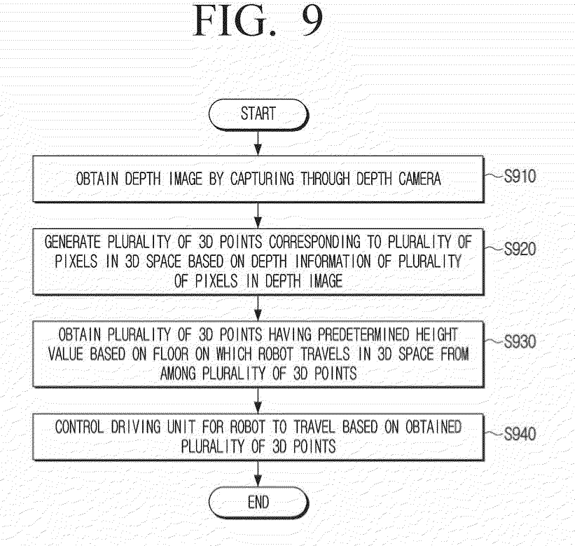

FIG. 9 is a diagram illustrating a flowchart of a method of controlling a robot according to an embodiment of the disclosure.

Referring to FIG. 9, a control method of the robot 100 may include obtaining a depth image by capturing through the depth camera 110 provided in the robot 100 in operation S910, generating a plurality of 3D points in a 3D space that corresponds to a plurality of pixels based on depth information of the plurality of pixels in the depth image in operation S920, identifying a plurality of 3D points having a predetermined height value based on the floor on which the robot 100 travels in the 3D space from among the plurality of 3D points in operation S930, and controlling the driving unit 120 provided in the robot 100 for the robot 100 to travel based on the identified plurality of 3D points in operation S940.

Specifically, the control method of the robot 100 may include, in operation S910, obtaining a depth image by performing capturing through the depth camera 110 provided in the robot 100.

In operation S920, a plurality of 3D points may be generated in a 3D space that corresponds to a plurality of pixels based on depth information of the plurality of pixels in the depth image.

In operation S930, a plurality of 3D points having a predetermined height value may be identified based on the floor on which the robot 100 travels in the 3D space from among the plurality of 3D points. The predetermined height value may be a height value set based on a height value of the robot.

In an embodiment, the identifying may include determining the floor on which the robot 100 travels in the 3D space based on a distribution of the plurality of 3D points in the 3D space.

The identifying may include rotating the plurality of 3D points in the 3D space such that the determined floor is mapped on the predetermined plane in the 3D space, and identifying the plurality of 3D points having a predetermined height value based on the predetermined plane from among the rotated plurality of 3D points.

The predetermined plane may correspond to the XZ plane in the 3D space which is defined by the X- axis, the Y- axis, and the Z-axis. In this case, the identifying may include identifying the plurality of 3D points of which the Y-axis value includes a predetermined value from among the rotated plurality of 3D points.

The identifying may include converting the identified plurality of 3D points to 2D data based on the X-axis value and the Z-axis value of the identified plurality of 3D points.

The identifying may include identifying the plurality of 3D points having a height value within a predetermined threshold range that includes the predetermined height value based on the floor from among the plurality of 3D points.

In operation S940, the driving unit 120 provided in the robot 100 may be controlled for the robot 100 to travel based on the identified plurality of 3D points.

The controlling may include controlling the driving unit 120 for the robot 100 to travel based on the 2D data.

According to an embodiment of the disclosure, an advantage of obtaining map data of various heights without specific limitation being possible compared to a LIDAR is provided, and there may be cost competitiveness, and miniaturization of a sensor may be possible.

According to an embodiment of the disclosure, computational load for estimating a position of the robot may be reduced. In addition, by utilizing depth image which minimizes the occurrence of blurring, accuracy in position estimation of the robot may be improved.

The various embodiments of the disclosure may be implemented with software including instructions stored in a machine-readable storage media (e.g., computer). The machine may call an instruction stored in the storage medium, and as a device operable according to the called instruction, may include an electronic device (e.g., robot 100) according to the above-mentioned embodiments. Based on the instruction being executed by the processor, the processor may directly or using other elements under the control of the processor perform a function corresponding to the instruction. The instruction may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

A method according to the various embodiments may be provided included a computer program product. The computer program product may be exchanged between a seller and a purchaser as a commodity. The computer program product may be distributed in the form of a machine-readable storage medium (e.g., a compact disc read only memory (CD-ROM)), or distributed online through an application store (e.g., PLAYSTORE™). In the case of online distribution, at least a portion of the computer program product may be at least stored temporarily in a server of a manufacturer, a server of an application store, or a storage medium such as a memory of a relay server, or temporarily generated.

Each of the elements (e.g., a module or a program) according to various embodiments may be formed as a single entity or a plurality of entities, and some sub-elements of the abovementioned sub-elements may be omitted, or different sub-elements may be further included in the various embodiments. Alternatively or additionally, some elements (e.g., modules or programs) may be integrated into one entity to perform the same or similar functions performed by the respective elements prior to integration. Operations performed by a module, a program, or another element, in accordance with various embodiments, may be executed sequentially, in a parallel, repetitively, or in a heuristic manner, or at least some operations may be executed in a different order, omitted or a different operation may be added.

What is claimed is:

1. A robot, comprising:
a depth camera;
a driver; and
a processor configured to,
control the depth camera to obtain a depth image, the depth image comprising depth information of a plurality of pixels in the depth image,
generate a first plurality of three-dimensional (3D) points corresponding to the plurality of pixels in a 3D space based on the depth information,
identify, from among the first plurality of 3D points, a second plurality of 3D points having a predetermined height value based on a floor on which the robot travels in the 3D space, and
control the driver to move the robot based on the second plurality of 3D points.

2. The robot of claim 1, wherein the processor is further configured to determine, based on a distribution of the second plurality of 3D points in the 3D space, the floor on which the robot travels in the 3D space.

3. The robot of claim 2, wherein the processor is further configured to:
rotate the second plurality of 3D points in the 3D space such that the determined floor is mapped on a predetermined plane in the 3D space, and
identify, from among the rotated second plurality of 3D points, a third plurality of 3D points with the predetermined height value based on the predetermined plane.

4. The robot of claim 3, wherein the predetermined plane corresponds to an XZ plane in the 3D space that is defined by a X-axis, a Y-axis, and a Z-axis, and
wherein the processor is further configured to identify, from among the rotated second plurality of 3D points, a fourth plurality of 3D points of which a Y-axis value has a predetermined value.

5. The robot of claim 4, wherein the processor is further configured to:
convert the fourth plurality of 3D points to two-dimensional (2D) data based on a X-axis value and a Z-axis value of the fourth plurality of 3D points, and
control the driver for the robot to travel based on the 2D data.

6. The robot of claim 1, wherein the processor is further configured to:
identify, from among the first plurality of 3D points, a fifth plurality of 3D points with a height value that is within a predetermined threshold range, the predetermined threshold range comprising the predetermined height value, and
control the driver to move the robot based on the fifth plurality of 3D points.

7. The robot of claim 1, wherein the predetermined height value is set based on a height value of the robot.

8. A method of controlling a robot, the method comprising:
obtaining a depth image by a depth camera provided in the robot, the depth image comprising depth information of a plurality of pixels in the depth image;
generating a first plurality of three-dimensional (3D) points corresponding to the plurality of pixels in a 3D space based on the depth information;
identifying, from among the first plurality of 3D points, a second plurality of 3D points with a predetermined height value based on a floor on which the robot travels in the 3D space; and
controlling a driver included in the robot to move the robot based on the second plurality of 3D points.

9. The method of claim 8, wherein the identifying comprises determining, based on a distribution of the second plurality of 3D points in the 3D space, the floor on which the robot travels in the 3D space.

10. The method of claim 9, wherein the identifying comprises:
rotating the second plurality of 3D points in the 3D space such that the determined floor is mapped on a predetermined plane in the 3D space, and
identifying, from among the rotated second plurality of 3D points, a third plurality of 3D points with the predetermined height value based on the predetermined plane.

11. The method of claim 10, wherein the predetermined plane corresponds to an XZ plane in the 3D space that is defined by a X-axis, a Y-axis, and a Z-axis, and
wherein the identifying comprises identifying, from among the rotated second plurality of 3D points, a fourth plurality of 3D points of which a Y-axis value has a predetermined value.

12. The method of claim 11, wherein the identifying comprises converting the second plurality of 3D points to two-dimensional (2D) data based on a X-axis value and a Z-axis value of the second plurality of 3D points, and
wherein the controlling comprises controlling the driver to move the robot based on the 2D data.

13. The method of claim 8, wherein the identifying comprises:
identifying, from the first plurality of 3D points, a fifth plurality of 3D points with a height value that is within a predetermined threshold range that comprises the predetermined height value based on the floor.

14. The method of claim 8, wherein the predetermined height value is set based on a height value of the robot.
